(19) United States
(12) Patent Application Publication
(10) Pub. No.: US 2013/0025153 A1
(43) Pub. Date: Jan. 31, 2013

(54) METHOD AND SYSTEM FOR DRYING BIOMASS

(71) Applicants: Jala Bin Mengat, Kajang (MY); Mohammad Ghaddaffi Bin Moh Noh, Kajang (MY); Muhammad Adlan Bin Abdullah, Kajang (MY)

(72) Inventors: Jala Bin Mengat, Kajang (MY); Mohammad Ghaddaffi Bin Moh Noh, Kajang (MY); Muhammad Adlan Bin Abdullah, Kajang (MY)

(73) Assignee: Petroliam Nasional Berhad (Petronas), Kuala Lumpur, (MY)

(21) Appl. No.: 13/637,196

(22) PCT Filed: Feb. 25, 2011
(86) PCT No.: PCT/MY2011/000017

§ 371 Date: Sep. 25, 2012

(30) Foreign Application Priority Data
Mar. 31, 2010 (MY) PI 2010001449

(51) Int. Cl. F26B 3/00; F26B 19/00

(52) U.S. Cl. 34/282; 34/86

(57) ABSTRACT

Disclosed herein is a drying method and system for removing water from biomass material. The method comprising the steps of: (a) heating said biomass material with a heating fluid to release water from said biomass by evaporation, wherein the heating fluid has been heated with heat generated by a chiller condenser condensing refrigerant from a gas phase to a liquid phase; (b) recovering heat from said heating fluid that has been in contact with said biomass in step (a), by thermally coupling the heating fluid to the refrigerant in the liquid phase to thereby evaporate the refrigerant to the gas phase.

### TECHNICAL FIELD

The present application relates to a novel method and apparatus for drying biomass.

### BACKGROUND

Biomass can be broadly defined as the organic matter derivable from organic sources. Typically, biomass includes agricultural waste such as coconut husks and rice hulls, forestry waste such as chip wood and branches, fecal matter from animals. Even more recently, human food waste and sewage sludge are also explored as possible sources of biomass.

In order to utilize biomass as a viable form of fuel source (bio-fuel), it is essential that the moisture content in the biomass material be sufficiently removed.

In one known method of drying biomass, a stream of hot gas ranging from 100° C.-180° C. is introduced into the body of biomass until the average moisture content of the biomass material is reduced to a desired level. The stream of hot gas is generated by an external burner, for example, a steam coil. The generated hot as is then passed through a drying chamber, whereby the biomass is housed, and thereafter escapes via exit conduits installed on the drying chamber. However, such a method requires an external heat source for heating up the gas stream used for drying the biomass, and results in significant energy consumption. In addition, the coefficient of performance for such a method is typically quite low as not all the energy supplied to the heat source is converted to the heat energy residing in the drying medium (i.e. air). Furthermore, the heated gas stream is only passed through the biomass material in a single pass operation. As a result, this method suffers from sub-par drying and low energy efficiency. The saturated heated gas escaping the drying chamber also causes significant heat pollution, and in other cases, odor pollution as well.

In another known method, the biomass is first ground to fine particulates, having an average particle size about 1-5 mm. The ground biomass is then treated with oil at a temperature from 120° C.-300° C. with an applied pressure and is further subjected to a drying step in oil at 120-200° C. This method similarly suffers from drawbacks of needing to invest heat energy in providing the heated oil for treating and drying the biomass. In addition, such a method inevitably requires a subsequent separation step whereby the oil is removed from the dried biomass. The need for further processing of the heated oil renders the method cumbersome and potentially capital intensive due to the need to install separation equipment. Further, the disposal of the used heated oil may pose further logistical difficulties and environmental problems, such as organic waste and heat pollution.

In another known method, there is disclosed a method for drying biomass which involves the mechanical crushing of the biomass to remove the water. In this method, the biomass is placed within a chamber and a ram is used to apply crushing pressure on the biomass, thereby removing the water therefrom. As can be readily appreciated, the rate and extent of water removal using mechanical crushing is not efficient. Such a method may yield biomass with wet basis as high as 100% and biomass obtained from such a process is not directly suited for use as bio-fuel.

Accordingly, there is a need to provide a method for drying biomass that overcomes, or at least ameliorates, the disadvantages mentioned above. In particular, there is a need to provide a method for drying biomass that is energy efficient. There is also a need to provide a system for drying biomass that has an improved capacity for drying, takes up lesser space (i.e. occupies a smaller footprint) and is capable of minimizing heat pollution.

### SUMMARY

In a first aspect, there is provided a method for removing water from biomass material, the method comprising the steps of: (a) heating said biomass material with a heating fluid to release water from said biomass by evaporation, wherein the heating fluid has been heated with heat generated by a chiller condenser condensing refrigerant from a gas phase to a liquid phase; and (b) recovering heat from said heating fluid that has been in contact with said biomass in step (a), by thermal coupling the heating fluid to the refrigerant in said liquid phase to thereby evaporate the refrigerant to the gas phase.

Advantageously, during the recovering step (b), the heating fluid loses heat energy through both sensible and latent heat transfer to the refrigerant liquid in the evaporator. As a consequence, heat energy is recovered from the spent heating fluid and this recovered heat energy may be recycled to impart heat to the incoming heating fluid that has not passed the biomass material.

Also advantageously, the heating fluid that is discharged into the environment has been cooled significantly and therefore reduces heat pollution.

In one embodiment, the method may further comprise a step of: (c) at least partially removing water from the heating fluid prior to said heating step (a). Step (c) is therefore a pre-drying step. The pre-drying step (c) is capable of removing a significant portion of moisture from the heating fluid, prior to the heating fluid being passed through the biomass material. As such, the drying capacity of the heating fluid is substantially increased.

In one embodiment, the pre-drying step (c) comprises thermally coupling the heating fluid to a refrigerant liquid in a chiller evaporator. The evaporator is relatively cool as energy escapes in the form of heat of vaporization due to the evaporation of the liquid refrigerant. Upon heat exchange between the refrigerant and the heating fluid, which is typically at ambient temperature at this stage, the evaporator cools the heating fluid below its dew point and thus condenses the moisture content entrained therein. The condensed water is subsequently removed and a stream of pre-dried, de-humidified heating fluid is obtained.

The method may also comprise, after the pre-drying step (c) above, a step of re-heating the de-humidified heating fluid to initial ambient temperature or higher, prior to the heating step (a). In one embodiment, the step of re-heating the de-humidified heating fluid may be achieved by thermally coupling the de-humidified heating fluid with a refrigerant in a chiller condenser. The chiller condenser is relatively hot due to the heat of condensation imparted to the condenser by, for instance, the condensation of gaseous refrigerant within the chiller condenser.

Advantageously, the re-heating step increases the temperature of the heating fluid and reduces the heat load required for raising the temperature of the heating fluid subsequently for the purposes of drying biomass material.

During the heating step (a), the heating fluid is at a temperature of from about 100° C. to about 250° C. In one embodiment, the heating fluid is from about 100° to about 200° C., from about 100° C. to about 175° C., or from about 100° C. to about 150° C. An additional heat source may be provided to further heat the heating fluid to a temperature of about 200° C. to about 350° C. prior to passing the biomass material. More preferably, the heating fluid is heated to about 250° C. to about 350° C., even more preferably, about 300° C. to about 350°. Suitable additional heat sources may include, but are not limited to, steam coils, burners and heat exchangers. In one embodiment, the heating fluid is heated to the above disclosed temperature ranges by thermally coupling heating fluid with one or more chiller condensers.

Heat transfer takes place between the hot chiller condenser and the heating fluid, thereby heating up the heating fluid. Advantageously, by heating the heating fluid in this manner, the coefficient of performance (or COP) can be about several times higher, when compared to conventional direct heating processes using steam coils or other types of burners. The COP of direct heating is typically about 1. In one embodiment, the COP of the present method is more than 1. In another embodiment, the COP of the present method is preferably not less than 4, even more preferably, not less than 5. Advantageously, a high COP indicates that the process is thermodynamically more efficient than conventional processes which employ direct heating.

The method of the first aspect may further comprise housing the biomass material in a drying chamber having a water removal path disposed therein. The biomass material may be passed along the water removal path, from a zone of higher temperature to a zone of lower temperature to remove water as the biomass traverses the water removal path. The water removal path may be in the form of a conveyor, such as a perforated screw feeder or auger, which moves the biomass through the chamber from a treatment zone of higher temperature to a zone of relatively lower temperature as water is being continually removed therefrom.

Advantageously, the mobile nature of the biomass material may help to promote more uniform drying. Also advantageously, the movement of the biomass material may also increase the contacting surface area between the biomass material and the heating fluid, thereby increasing the total surface area available for heat exchange and drying. Consequently, this improves the drying efficiency of the heating fluid and provides a substantially dehydrated biomass end product. Also, advantageously, the biomass in the drying zone is in a more compact form rather than in loose form, thus reducing the dryer footprint for same drying capacity.

In one embodiment, the footprint of the drying chamber may be reduced by 20% to 50%, relative to conventional dryers which typically span from about 30-45 meters by about 3-6 meters, without substantial reduction in its throughput capacity. In one embodiment, the instant drying chamber is capable of having a throughput capacity of 1-2 MT/hr.

In one embodiment, the drying chamber may comprise an extruder or a perforated auger, configured to advance the biomass material through one or more heating temperature zones, with each zone describing a graduated temperature difference relative to its adjacent preceding zone.

As the heating fluid is passed through the biomass during step (a), it gradually becomes more saturated as water is evaporated from the biomass material and is carried off in the spent heating fluid stream.

In the recovering step (b), the spent heating fluid which has become saturated with moisture is thermally coupled with a refrigerant liquid in a chiller evaporator to at least partially recover heat from the spent heating fluid stream.

In one embodiment, the chiller comprises an evaporator means for evaporating refrigerant and may therefore be utilized as a cooling source for recovering heat. The chiller also comprises a condenser means for condensing refrigerant and may be utilized as a heat source for imparting heat to the heating fluid stream.

The liquid refrigerant in the evaporator may be capable of recovering heat from the spent heating, fluid stream. Advantageously, the recovered heat may be utilized to raise the temperature of the heating fluid prior during heating step (a). More advantageously, this recycle of heat lowers the heat load required to raise the heating fluid to the desired temperature of about 100° C. to about 150° C. Also advantageously, the spent heating fluid stream is cooled before being discharged to the environment, thereby reducing the heat pollution caused by the discharge.

The chiller condenser responsible for heating the heating fluid prior to step (a), may be suitably arranged to, utilize the recycled heat described above for heating the heating fluid. In one embodiment, the condenser may be arranged to be disposed upstream of the drying chamber, capable of imparting heat to the heating fluid prior to heating step (a).

The disclosed method may further comprise a step of drying the biomass in compact form during said heating step (a). Suitable mechanical means may be provided within the drying chamber to move the biomass housed therein. Exemplary mechanical means may include, but are not limited to, augers, perforated augers, conveyor systems and/or extruders. Advantageously, this method is capable of drying the biomass in a compact form as compared to conventional dryers, and therefore achieves a higher throughput of substantially dried biomass. Advantageously, the disclosed method also reduces the footprint of the dryer, saving space and lowering costs.

According to a second aspect, there is provided a system for removing water from biomass, said system comprising: one or more primary chillers configured to provide heat to a heating fluid stream by condensing refrigerant in a gas phase to a liquid phase, a biomass treatment zone capable of housing biomass material and being configured to receive heating fluid that has been heated by said one or more primary chillers for removing water from biomass; wherein said liquid refrigerant is thermally coupled to said heating fluid that has passed through said biomass treatment zone to recover heat therefrom.

The system may further comprise a secondary chiller, said secondary chiller being configured to at least partially remove water from said heating fluid stream, prior to being passed to said primary chiller. In one embodiment, the secondary chiller does not substantially reduce the temperature of the heating fluid stream.

In one embodiment, the system may comprise a plurality of primary chillers. The primary chillers may comprise a plurality of respective condensers thermally coupled to the heating fluid stream, wherein the plurality of condensers is capable of raising the temperature of the heating fluid successively, before the heating fluid is passed through the biomass treatment zone.

In one embodiment, the plural condensers may be arranged sequentially or in series to allow for successive heating of the heating fluid. In a preferred embodiment, there may be at least two condensers thermally coupled to the heating fluid stream, and arranged in series to impart heat onto the heating fluid successively.

The plurality of primary chillers may also comprise a plurality of evaporators which are thermally coupled to the heating fluid stream that has passed through the biomass treatment zone. The plurality of evaporators may be arranged suitably to recover heat from the heating fluid stream successively. In one embodiment, the evaporators are arrange in series.

The biomass treatment zone may comprise a water removal path over which said biomass travels. The heating stream may be disposed along one heating zone of said water removal path to remove water from the biomass. In one embodiment, the heating fluid stream progressively decreases in temperature as it passes the biomass disposed along the water removal path.

In one embodiment, the system may comprise a conveying means to move the biomass through said biomass treatment zone. In one embodiment, the conveying means is a perforated auger configured to rotate and move said biomass along said biomass treatment zone.

### DEFINITIONS

The following words and terms used herein shall have the meaning indicated:

The term “biomass” as used in the context of the present specification, is to be interpreted broadly to refer to organic matter derivable from organic sources. Included in biomass are cellulose, including hemicellulose, other carbohydrates and proteins, lignins, and extractable (e.g., resins and tars.)). There are a number of sources of biomass material such as crops {e.g., palm oil plant, sugar cane, sugar beets), trees, shrubs, grasses, plankton (e.g, phyloplanktan, zooplankton, bacterioplankton), algae, macroalgae (e.g., species from the genus Sargassum), seaweed, agricultural waste (e.g., corn husks, bushes, and weeds).

The term “coefficient of performance”, as used in the context of the present specification, is a dimensionless constant, which refers to the ratio of the change in heat energy at the reservoir of interest (i.e. δQ) to the amount of energy supplied to said reservoir (i.e. δW), typically expressed as |δQ/δW|.

The term “chiller” in the context of this specification refers to a device or unit operation which has an evaporator function and compressor function. The term “condenser”, as used in the context of the present specification, refers to a thermodynamic device or unit for condensing vapor into liquid by compression while the term “evaporator”, refers to a thermodynamic device or unit for converting liquid into vapor by expansion, evaporation or heating.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”; and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DISCLOSURE OF OPTIONAL EMBODIMENTS

Exemplary, non-limiting embodiments of the method for drying biomass will now be disclosed.

The heating fluid may be selected from gaseous or liquid mediums. Preferably, the heating fluid is chemically inert to the biomass to minimize or prevent any reactions with the biomass material from occurring. Preferably, the heating fluid is capable of entraining substantial amounts of moisture therein. Even more preferably, the heating fluid should have a high saturation capacity such that it can be loaded with a high content of moisture. In one embodiment, the heating fluid is air. In another embodiment, the heating fluid is carbon dioxide.

The biomass as described above may be selected from the group consisting of, but not limited to, wood, plant or animal waste, compost, municipal waste, alcohols, and other biodegradable waste. In a preferred embodiment, the biomass is derived from a plant source. In a further preferred embodiment, the biomass material is empty fruit bunches (EFB). In one embodiment, the biomass material may be EFB fiber.

After the pre-drying step, the moisture content of the de-humidified air is in a range from about 10% relative humidity (RH) to about 40% RH, from about 10% RH to about 30% RH, from about 10% RH to about 20% RH. In one embodiment, the de-humidified air is about 20% RH.

In the subsequent re-heating step, the de-humidified air is heated to a temperature of about 0° C. to about =20° C. relative to the initial heating fluid temperature. More preferably, the de-humidified air is re-heated to a temperature of about +5° C. to about ±10° C. above the initial temperature of the feed air. In one embodiment, the de-humidified air is re-heated to a temperature range of from about 25° C. to about 50° C., or from about 30° C. to about 45° C. The re-heated air stream may be further heated to a temperature of about 100° C. to about 350° C. prior to being passed through the biomass material to evaporate the water therefrom. In one embodiment, the air stream is heated to about 200° C. by thermal coupling to a condenser. If required, a make-up heater, such as a steam coil, burner or a heat exchanger may be included to provide additional heating duty. Overheating the air stream results in a waste of energy and increases cost, under-heating the air stream results in poor drying and/or longer drying period and the resultant dried biomass may be unsuited for further use.

With reference to the heating of the air stream, the coefficient of performance (COP_{heating}) may assume a value of about 3 to about 10. In a preferred embodiment, the COP_{heating} is at least 5.

Optionally, an actuating means may be used to the heated air stream over the biomass. The actuating means may also increase the heating fluid pressure to ensure good thermal contact with the compacted biomass in the drying chamber. The actuating means may be selected from the group consisting of, but not limited to, pumps, blowers, pressurized valves and compressors.

The pre-dried biomass material typically contains from about 40% percent by weight of water to about 60% percent by weight of water. After the drying process, the resultant biomass may contain from about 10% percent by weight of water to about 20% percent by weight of water. More preferably, the resultant biomass material contains not more than 15% percent by weight of water.

The expended heating fluid may also be routed back into the system for recycle, rather than being discharged into the surroundings. In one embodiment, the cooled, saturated heating fluid may be recycled to a chiller evaporator to remove the entrained moisture, before being re-heated and subsequently passed through the biomass.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic depicting the pre-dryer zone designed to remove humidity from the incoming feed air stream.

FIG. 2 is a schematic depicting the primary drying zone, whereby the biomass is dried by the heated feed air.

FIG. 3 discloses the overall integrated drying system disclosed in FIG. 1 and FIG. 2.

FIG. 4 shows a preferred embodiment the primary drying zone of FIG. 2.

FIG. 5 shows one possible embodiment of the drying means in accordance with the present invention.

### DETAILED DESCRIPTION

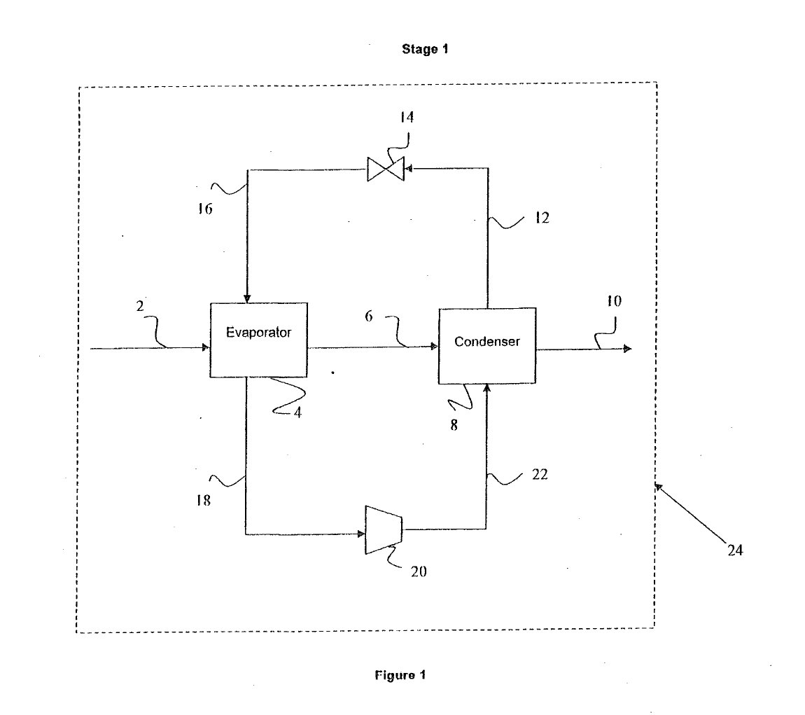

Referring now to FIG. 1, there is shown a schematic diagram of Stage 1 of a pre-drying zone 24. Ambient moist air 2 enters an evaporator 4 through a feed inlet (not shown).

Evaporator 4 takes in moist ambient air 2 from the surroundings. The moist ambient air 2 is then thermally coupled with refrigerant 16 residing in evaporator 4, thereby cooling the moist ambient air 2 to dew point or to a lower temperature.

As a result, moisture content entrained in the moist air 2 is condensed out as water. This cooling step advantageously removes a significant amount of moisture from the ambient air 2 stream, de-humidifying the ambient air 2 in the process. The de-humidified air 6 then passes into a condenser 8, wherein the de-humidified air 6 is thermally coupled with condenser 8.

The refrigerant 18 is passed through a compressor 20, forming a compressed refrigerant 22, which is thereafter passed towards condenser 8.

In the condenser 8, the refrigerant 22 is condensed and releases heat energy in the form of latent heat of condensation. The released heat energy is taken up by de-humidified air 6 during heat exchange and the de-humidified air 6 is heated up accordingly. In particular, the de-humidified air 6 is heated to at least the initial ambient temperature or higher. The refrigerant 12 thereafter flows through an expander 14, and the expanded refrigerant 16 is looped back towards the evaporator 4.

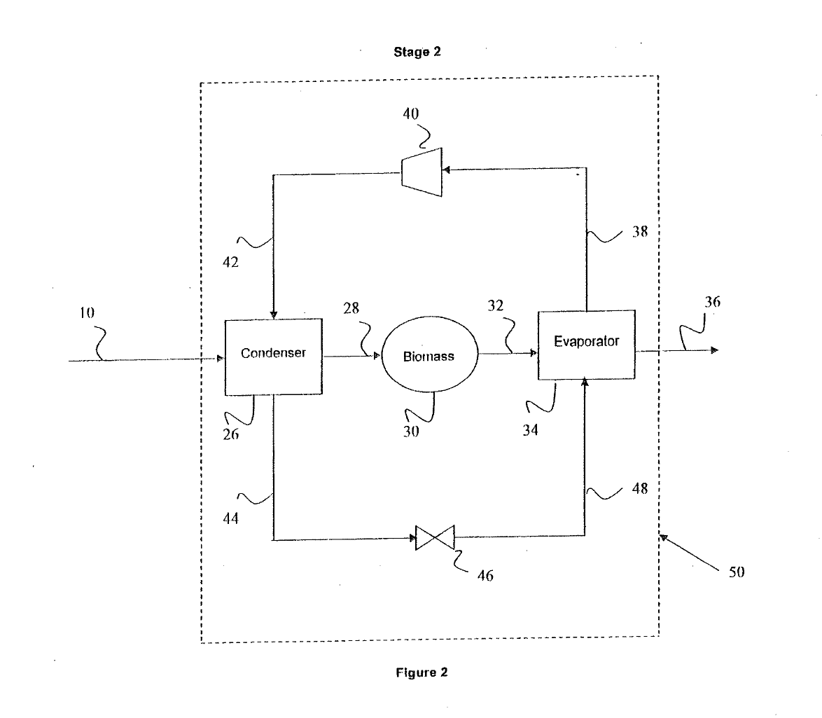

The dehumidified air 10 leaves the chiller condenser and continues along the passages to Stage 2 of the chiller drying system (See FIG. 2).

Referring now to FIG. 2, there is shown a schematic diagram of Stage 2, which is the primary drying zone 50. The de-humidified air 10 from Stage 1 (FIG. 1) is thermally coupled with a condenser 26, wherein the de-humidified air 10 is heated UD by the refrigerant 42 residing in condenser 26.

As the refrigerant 42 flows through condenser 26, refrigerant 42 condenses and releases a huge amount of heat as latent heat of condensation, thereby heating up the de-humidified air 10 as it passes through condenser 26 via sensible and latent heat transfer. As a result, the de-humidified air 10 is heated to temperatures ranging from 60° C. to about 90° C. To achieve the desired heated temperatures, a plurality of condensers similar to condenser 26 can be arranged in series, heating the de-humidified air 10 successively one after another to the desired temperatures ranging from 100° C. to about 150° C., more preferably from about 150° C. to about 250° C., even more preferably from about 250° C. to about 350° C. The de-humidified air 10 subsequently exits the condenser 26 as heated air 28. The refrigerant 42 exits condenser 26 as a condensed refrigerant stream 44 and is passed through an expander 46. The expanded refrigerant 48 is then routed towards evaporator 34.

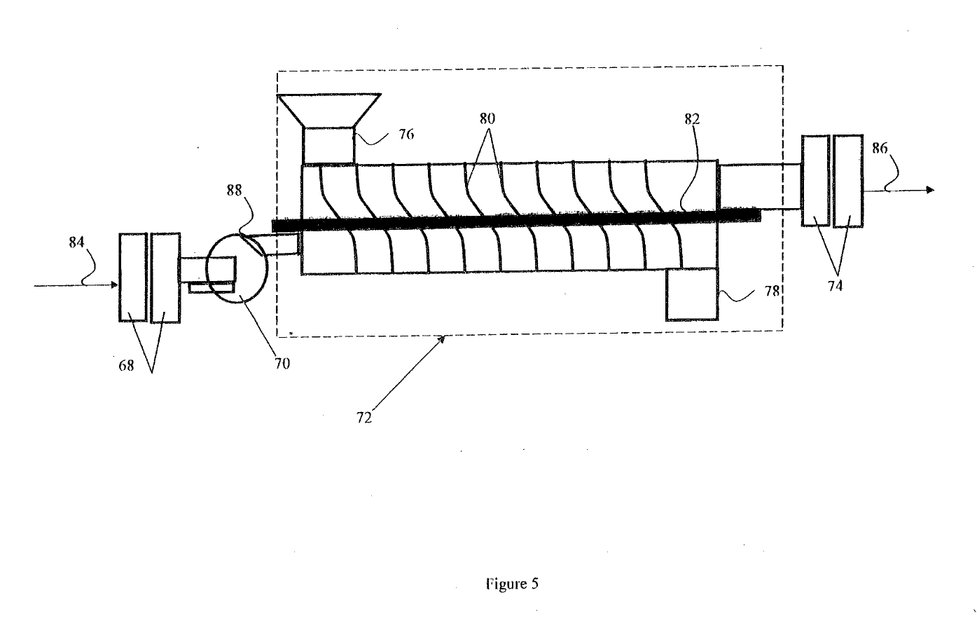

The heated air 28 exiting condenser 26 is then passed through a body of biomass material 30, to thereby remove completely, or at least substantially reduce, the water content present in the biomass material 30. The water evaporates from the biomass material 30 and becomes entrained within heated air 28, resulting in the formation of a spent, saturated air 32. The biomass to be dried is passed into a perforated auger (not shown), where it is thermally contacted with the heated air 28. This will be further described in FIG. 5

The saturated air 32 is then thermally coupled with evaporator 34 to at least partially recover the heat energy, which in turn reduces the temperature of the spent air 32. Spent air 32 then exits the drying system as saturated air 36.

A plurality of evaporators can be arranged in series to successively reduce the temperature of spent air 32 to about ambient temperature. As a result, excess heat from the saturated air 32 is at least partially or substantially recovered in the process.

This further reduces the heating duty placed on condenser 26, and is advantageously energy saving. As a result of the above heat exchange, saturated air 32 is cooled prior to being discharged as cooled air 36. The cooled air 36 can be discharged directly to the environment without causing excessive heat waste.

The refrigerant 48 exits evaporator 34 as refrigerant 38 and is thereafter routed to a compressor 40. The compressed refrigerant exits the compressor 40 as compressed fluid 42, whereby it is looped back towards condenser 26 for providing heating to feed air 10. A plural of chiller system is arranged in to progressively heating the de-humidified air 10 and conversely to reduce the temperature of saturated air 32 progressively to ambient temperature level.

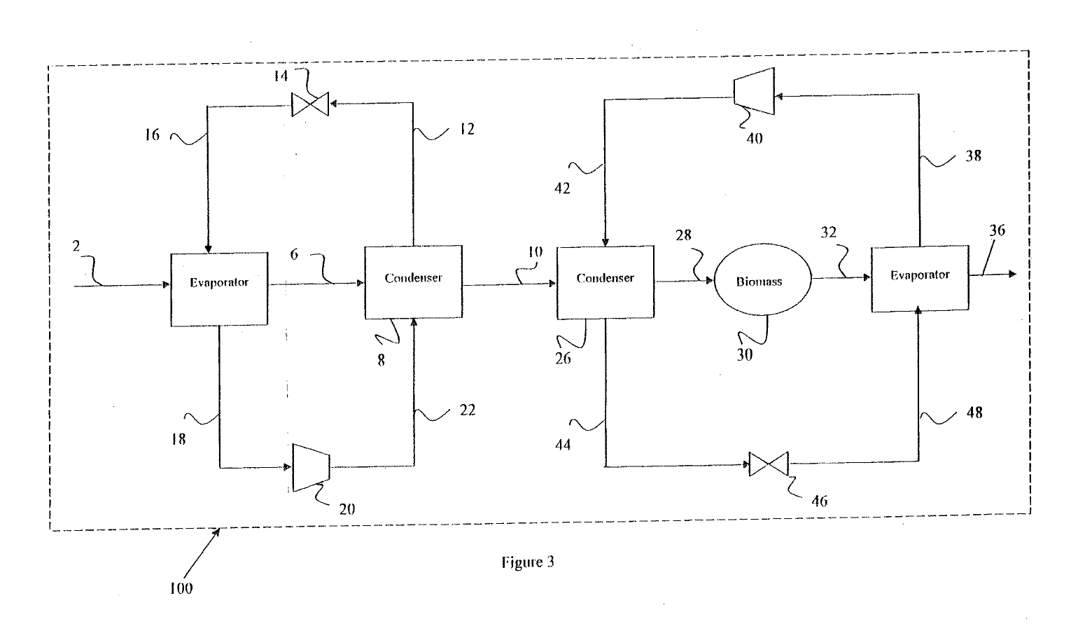

FIG. 3 depicts the integrated drying system 100, comprising the pre-drying zone 24 and the primary drying zone 50 as in FIGS. 1 and 2 respectively. The mode of operation is as described above.

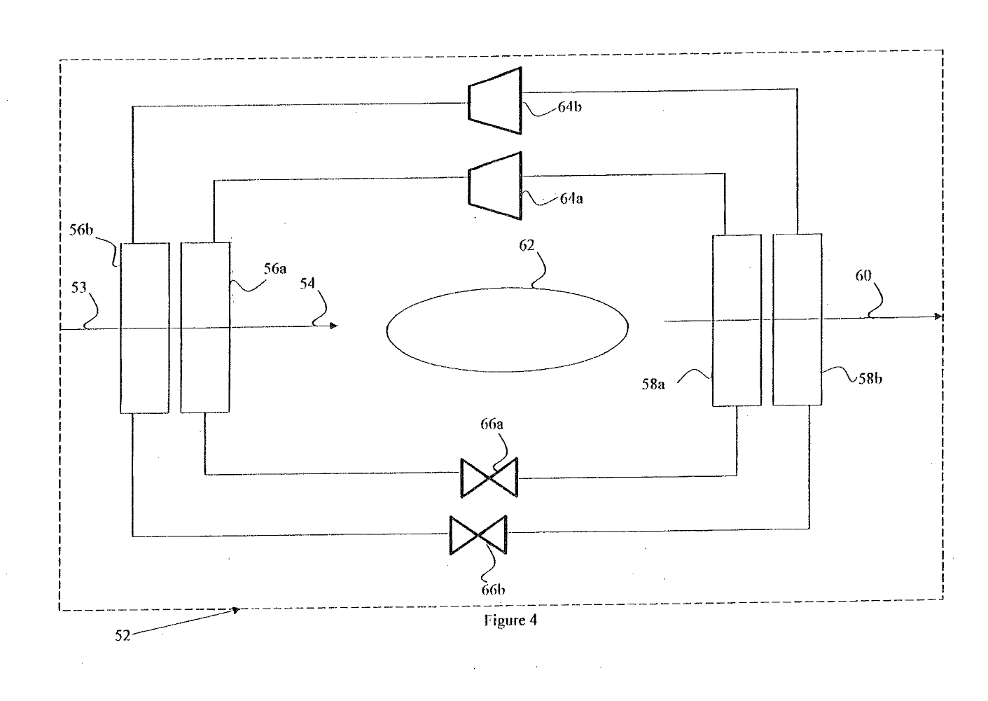

Now referring to FIG. 4, there is shown a preferred embodiment 52 of the primary drying zone 50. Air 53 that has been de-humidified and re-heated from pre-drying step 24 is thermally contacted with a zone of condensers 56b, 56a. At least two condensers is envisaged (and currently depicted in FIG. 4). However, it is also envisaged that more than two condensers can be used, depending on the preferred temperature of the heated air 54. In this embodiment, the air 54 is heated to about 60-90° C. by condenser 56b and to about 90-150° C. by condenser 56a.

In operation, the refrigerant residing in condensers 56a, 56b is condensed by compressors 64a, 64b respectively. The resultant latent heat of condensation released by the condensed refrigerant is then imparted as heat onto air 54 in succession. The refrigerant then passes to expander valves 66a, 66b and evaporates within evaporators 58a, 58b.

The heated air 54 thermally contacts the biomass material 62 and removes moisture from the biomass and forms saturated, spent air 60. The spent air 60, having passed the biomass material 62, and is thermally coupled with evaporators 58a and 58b in succession. The cool refrigerant residing in evaporators 58a, 58b recover heat energy from spent air 60. In this embodiment, the temperature of spent air 60 is first reduced by evaporator 58a to about 90-60′C, and further reduced to about 40-30° C. by evaporator 58b. Same as the condensers, while only two evaporators are depicted here, more than two evaporators are envisaged to provide the cooling capacity as needed.

Now referring to FIG. 5, an exemplary drying means in the form of a perforated auger 72 is shown. Perforated auger 72 comprises a central rotating shaft 82, having a plurality of helical flighting 80, provided thereon. Biomass material is fed into the auger 72 via feed inlet 76. In operation, the helical (lighting 80 assists in the continuous transportation of biomass material from the inlet 76 to the biomass outlet 78, as the rotating shaft 82 rotates at a predetermined speed. The rotating speed of the shaft 82 can be carefully controlled to obtain a desired drying residence time.

Incoming air 84 is heated by a condenser zone 68, comprising two or more condensers arranged in succession. The heated air is then forced into the auger 72 at high pressure using a blower 70 via air inlet 88. The spent air 86 which is saturated with water removed from the biomass is thermally coupled with an evaporator zone 74 to at least partially recover heat therefrom. Similar to condenser zone 68, the evaporator zone 74 comprises two or more evaporators arranged in series to successively recover heat from spent air 86.

### Applications

The disclosed method for drying biomass of the present invention may be applied in numerous industrial applications, not least in the utilization of biomass as quality fuels for heaters, industrial boilers and as raw material for pulp mills.

By employing the “cold” and “hot” ends of the respective evaporators and condensers of chillers, the disclosed method is capable of incorporating common sub-units which are typically installed in common air-conditioning units, for the purposes of de-humidifying and drying biomass material. This advantageously recycles the waste heat emitted by condenser units and allows for significant energy savings. Advantageously, the disclosed method minimizes the consumption of fuel (for the burners) and reduces energy costs.

Through an innovative arrangement of the condensers and evaporators, the disclosed method is further capable of recovering waste heat from the saturated air (i.e., the spent heating fluid) that has already passed through the biomass material. The recovered heat can thereafter be recycled to heat up the dried air that is about to pass through the biomass. Advantageously, such heat integration reduces the heat duty placed upon the condenser and further saves energy and costs. More advantageously, by recycling the recovered heat, the disclosed method also boasts of a coefficient of performance several times that of conventional direct heating. Consequently, the disclosed method has an enhanced drying capacity and is capable of handling a high throughput of biomass.

Furthermore, the disclosed method discharges spent air that has been substantially cooled due to the heat recovery prior to discharge. Advantageously, the disclosed method is capable of minimizing heat pollution.

It will be apparent that various other modifications and adaptations of the invention will be apparent to the person skilled in the art after reading the foregoing disclosure without departing from the spirit and scope of the invention and it is intended that all such modifications and adaptations come within the scone of the appended claims.

1. A method for removing water from biomass material, the method comprising the steps of:
(a) heating said biomass material with a heating fluid to release water from said biomass by evaporation, wherein the heating fluid has been heated with heat generated by a chiller condenser condensing refrigerant from a gas phase to a liquid phase; and
(b) recovering heat from said heating fluid that has been in contact with said biomass in step (a), by thermally coupling the heating fluid to the refrigerant in said liquid phase to thereby evaporate the refrigerant to the gas phase.

2. The method of claim 1, further comprising the step of:
(c) at least partially removing water from said heating fluid prior to said heating step (a).

3. The method of claim 2, wherein said water removal step (c), comprises the step of:
(d) cooling said heating fluid to below the dew-point of said fluid.

4. The method of claim 3, wherein after said cooling step (d), the method comprises the step of:
(e) heating the heating fluid to initial ambient temperature or higher.

5. The method of claim 3, wherein said cooling step (d) comprises thermally coupling said heating fluid to refrigerant in a chiller evaporator to remove water from said heating fluid.

6. The method of claim 4, wherein said heating step (e) comprises thermally coupling said heating fluid to a refrigerant in a chiller condenser.

7. The method of claim 1, wherein during said heating step (a), the heating fluid is heated to a temperature of from about 100° C. to about 250° C.

8. The method of claim 1, wherein during said heating step (a), the coefficient of performance (COP) is at least 1.

9. The method of claim 8, wherein during said heating step (a), the coefficient of performance (COP) is at least 3.

10. The method of claim 1, further comprising the step of:
(f) passing said biomass material along a water removal path to remove water as the biomass material moves along said water removal path.

11. The method of claim 1, comprising the step of:
(g) utilizing recovered heat from said recovering step (b) to heat said heating fluid in step (a).

12. The method of claim 1, further comprising the step of:
(h) drying said biomass material in a compact form in a drying chamber, during said heating step (a).

13. A system for removing water from biomass, said system comprising:
one or more primary chillers configured to provide heat to a heating fluid by condensing refrigerant from a gas phase to a liquid phase;
a biomass treatment zone capable of housing biomass material, and being configured to receive heating fluid that has been heated by said one or more primary chillers, for removing water from said biomass;
wherein said refrigerant in the liquid phase is thermally coupled to said heating fluid that has passed through said biomass treatment zone to recover heat therefrom.

14. The system as claimed in claim 13, wherein said system comprises a plurality of primary chillers.

15. The system as claimed in claim 13, further comprising a secondary chiller, said secondary chiller being configured to at least partially remove water from said heating fluid stream, prior to being passed to said one or more primary chillers.

16. The system as claimed in claim 14, wherein said plurality of primary chillers comprise a plurality of respective condensers, said condensers being thermally coupled to said heating fluid, and wherein said condensers are capable of heating said heating fluid stream successively to a higher temperature.

17. The system as claimed in claim 16, wherein two or more condensers are arranged in series to successively heat said heating fluid.

18. The system as claimed in claim 14, wherein said plurality of primary chillers comprise a plurality of respective evaporators, said evaporators being thermally coupled to said heating fluid stream that has passed through the biomass treatment zone, wherein said plurality of evaporators are arranged to recover heat successively from said heating fluid stream.

19. The system as claimed in claim 18, wherein two or more evaporators are arranged in series to recover heat successively from said heating fluid stream that has passed through the biomass treatment zone.

20. The system as claimed in claim 13, wherein the system further comprises a conveying means to move said biomass along said biomass treatment zone.

21. The system as claimed in claim 20, wherein said conveying means is a perforated auger.
